(19) United States
(12) Patent Application Publication
(10) Pub. No.: US 2011/0225728 A1
(43) Pub. Date: Sep. 22, 2011

(54) TYM-LYN PORTABLE LIFT SYSTEM

(76) Inventors: Lyn Thornhill, Cottam (CA); Tim Bezanson, Cottam (CA)

(21) Appl. No.: 13/052,029

(22) Filed: Mar. 18, 2011

Related U.S. Application Data
(60) Provisional application No. 61/315,525, filed on Mar. 19, 2010.

(51) Int. Cl. A61G 7/10

(52) U.S. Cl. 5/86.1

(57) ABSTRACT

A mobile patient lift system comprising: a frame assembly; the frame assembly including, a plurality of inter-lockable modular vertical frame posts, a plurality of variably lockable corner and vertical couplers, a top horizontal support bar with a lifting eye. The system further comprises a patient suspension bar; a lifting means; a driver bar assembly; two caster wheel assemblies with wheel locks; and optionally at least one horizontal stabilizer bar connectable between the modular vertical frame posts via T-shaped couplers. The mobile patient lift system is for use in lifting patients in hospitals, homes and other interior spaces.

### CROSS-REFERENCE TO RELATED APPLICATION

The present application is related to and claims priority from prior provisional application Ser. No. 61/315,525, filed Mar. 19, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

The following includes information that may be useful in understanding the present invention(s). It is not an admission that any of the information provided herein is prior art, or material, to the presently described or claimed inventions, or that any publication or document that is specifically or implicitly referenced is prior art.

### BACKGROUND OF THE INVENTION

1. Field of the Invention

The present invention relates generally to the field of lifts and more specifically relates to patient lifting systems.

2. Description of the Related Art

In modern societies, patients may live for extended periods in hospitals, nursing homes, and the homes of family members who care for them. As a result of their weakened condition patients often need to be moved frequently and may not be able to accomplish this on their own. The task as a result often falls to the care-giver. Moving patients from bed is the leading cause for health care professional back injuries due to the weight of the patient and the position the caregiver has to assume over the patient to perform lifting. To help with this problem, leveraged mechanical lift systems may be used as a safety measure and to assist the caregiver.

Presently, stationary lifts may allow patient(s) to be transferred between a bed and a chair or other similar resting places, using assisted power; however these lifts are often expensive, cumbersome to use and create a dangerous obstacle. The sit-to-stand lifts may be designed to help facilitate patient's mobility for those who lack the strength or muscle control to rise to a standing position from a bed, wheelchair, chair, or commode. These lifts use straps, vests, or belts (as opposed to slings) to make the transition possible. There has been considerable effort put forth by nursing advocacy groups to encourage hospitals and nursing homes to adopt “zero-lift” or “no-lift” programs in order to prevent orthopedic injuries in healthcare workers; however using current devices this is not feasible to implement.

The time and effort required to safely use present-day lift equipment also deters this from happening. For example—transferring a patient with a lift typically takes between three and six minutes which is considerably longer than moving a patient manually. Many times patient may fall when being manually lifted. “Lift teams” that are on call which specialize in moving patients may be used however the team may be busy when needed, the cost of extra personnel is costly, and patients who need to be mobilized quickly to meet schedules must wait for a team to become available. The inability to mobilize patients at home is one of the primary reasons that patients find it necessary to leave the home environment and enter a nursing home when they become temporarily or permanently disabled.

Caregivers may find it difficult to lift their disabled loved ones, especially as patients get older. The weight and height of a patient can cause difficulties for caregivers, especially caregivers who lack strength due to age or medical conditions. Many consumers cannot afford costly mobility devices, such as ceiling tracks and lift systems. Traditional lift systems cannot be easily disassembled or stored when not in use, causing unsightly and dangerous obstructions.

Various attempts have been made to solve the above-mentioned problems such as those found in U.S. Pat. Nos. 3,222,029; 3,711,877; 4,644,595; 6,430,761; 4,144,713; and 5,153,953. This prior art is representative of patient lift systems. None of the above inventions and patents, taken either singly or in combination, is seen to describe the invention as claimed.

Ideally, a patient lift system should be user-friendly, conveniently mobile, yet operate reliably, and be manufactured at a modest expense. Thus, a need exists for a reliable patient lift system to prevent caregiver back injuries and to avoid the above-mentioned problems.

### BRIEF SUMMARY OF THE INVENTION

In view of the foregoing disadvantages inherent in the known lifting means art, the present invention provides a novel patient lifting system. The general purpose of the present invention, which will be described subsequently in greater detail is to provide efficiency and convenience in moving patients.

A mobile patient lift system is disclosed herein preferably comprising: a frame assembly; the frame assembly including, a plurality of (inter-lockable) modular vertical frame posts, a plurality of variably lockable corner couplers, at least one top horizontal support bar with a lifting eye. The system further comprising a patient suspension bar; at least one lifter (lifting means); a driver bar assembly; at least two caster wheel assemblies with wheel locks (or other suitable mobility-enabling means); and optionally at least one horizontal stabilizer bar connectable between the modular vertical frame posts via T-shaped couplers.

The frame assembly preferably includes the plurality of modular vertical frame posts coupled to the variably lockable corner couplers and to the top horizontal support bar. These components form the modular frame assembly (structural framework) for the mobile patient lift system. In certain embodiments the modular vertical frame posts, the top horizontal support bar, and the horizontal stabilizer bar may be telescopic.

The variably lockable corner couplers may comprise biasing slits that may be manipulated by the adjacent rotatable lever (or other equivalent camming, locking means or the like) which provide for rotation means between locked and unlocked positions, whereby the device can be suitably secured in a couplably-secured relationship as an assembly. The variably lockable corner couplers preferably comprise perpendicularly-oriented tube receivers such that the top horizontal support bar with a lifting eye is able to be removably coupled with the modular vertical frame posts at right angles to create an open plane wherein the frame assembly is able to circumvent a bed.

The patient suspension bar of the present invention preferably comprises a center-located lift-eyelet which may be removably connected to the lower hook of the lifting apparatus. The lifting apparatus also has an upper hook which attaches to the top horizontal support bar via the lifting eye. The lower hook may be connected to a chain (cable/rope or equivalent) which is preferably feed through a ratchet and pawl mechanism of the lifter and then winds onto a spool for safely and conveniently storing the extra unused chain.

The lifter in the present invention is a torque multiplier that may be used in conjunction with a driver bar assembly. The driver bar assembly may comprise sprockets at each end for receiving and driving a continuously connected drive chain. The driver bar assembly functionally operates the mechanical lift via a sprocket at one end having a handle for caregiver manipulation at the other end, the handle in direct contact with the other sprocket. The driver bar assembly is preferably removably-secured to the lifter in a direct-drive relationship such that when the sprockets move, the chain on the driver bar assembly spool on the lifter is caused to move rotationally in accordance. In other embodiments the drive may be indirectly coupled.

The driver bar assembly is angle-mounted between the lifter and one of the modular vertical frame posts with the lifter is connected to the top horizontal support bar via a lifting eye. The driver bar assembly is angle-mounted between the lifter and one of the modular vertical frame posts such that the crank handle is able to be manipulated at a distance away from the patient to avoid manipulating the lift over top of the patient. As mentioned, the driver bar assembly further may comprise a crank handle for manual manipulation or an electric motor for automatic operation in other embodiments. The patient suspension bar is preferably removably connected to the lifter such that the patient suspension bar is able to be repeatably manipulated between up and down positions via the driver bar assembly to lift (or lower) at least one patient, with the patient removably attached to the patient suspension bar (via straps, cradles or the like.) The caster wheel assemblies provide smooth mobility for the unit along planar surfaces such as floors. The caster wheel assemblies removably receive the modular vertical frame posts of the frame assembly such that they may be in a locked relationship. In other embodiments feet may be used for stationary versions. Each of the caster wheel assemblies preferably include a plurality of swivelable wheels to distribute the load uniformly such that it is relatively easily to move/transport the mobile patient lift system on a planar surface between various locations, even in a loaded condition (holding a patient.)

A kit is also disclosed herein comprising wherein the kit may be easily assembled (for use) and disassembled (for shipping, storage, etc.). The kit preferably including: a frame assembly including a plurality of modular vertical frame posts; a plurality of variably lockable corner couplers; at least one top horizontal support bar with a lifting eye; a patient suspension bar; at least one lifter; a driver bar assembly; at least two caster wheel assemblies with wheel locks; and optionally at least one horizontal stabilizer bar.

A method for using the mobile patient lift system is also discussed herein, the method comprising the steps of: orientating a patient on an object; manipulating the mobile patient lift system over an object such as a bed or the like; coupling the patient to the mobile patient lift system to move the patient; and manipulating the mobile patient lift system from over the object to an out-of-the-way location.

The present invention holds significant improvements and serves as a patient lift system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Tym-lyn Portable Lift Systems (mobile patient lift systems), constructed and operative according to the teachings of the present invention.

FIG. 1 shows a perspective view illustrating a mobile patient lift system in an in-use condition according to an embodiment of the present invention.

FIG. 2 is a perspective view illustrating the mobile patient lift system in a non-use condition according to an embodiment of the present invention of FIG. 1.

FIG. 3 is a perspective view illustrating a lifter as attached to a top horizontal support bar and to a modular vertical frame post of the frame assembly of the mobile patient lift system according to an embodiment of the present invention of FIG. 1.

FIG. 4 is a perspective view illustrating two mobile patient lift systems in a stabilized condition circumventing a patient's bed according to an embodiment of the present invention of FIG. 1.

FIG. 5 is a perspective view illustrating the various components of the mobile patient lift system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a lifting system and more particularly to a mobile patient lift system as used to improve the speed and convenience of safely lifting and transporting patients.

Referring generally to the present invention, Tym-lyn Portable Lift 100 (mobile patient lift systems 102) affords caregivers the opportunity to move their disabled loved ones and transport them into areas not accessible by wheelchair or other similar mobility methods. Tym-lyn Portable Lift 100 substantially enables users to move freely from beds 180, into standard washrooms, and down hallways with relative ease. Tym-lyn Portable Lift 100 is designed to be lightweight, transportable, and is virtually maintenance-free. It is especially ideal for consumers who rent and cannot use ceiling lifts due to rental agreements or risk of ceiling damage that may prove expensive to repair.

Tym-lyn Portable Lift 100 in certain embodiments may be comprised of tubular metal (aluminum as shown, alternately non-metals may be used), preferably with two lockable corner couplers 110 and two lockable sections on each side. Triangular caster wheel assemblies 120 with a plurality of lockable wheels 130 (three shown) may be included on each side of Tym-lyn Portable Lift 100 providing mobility. The plurality of modular vertical frame posts 140 can be made in two pieces (modularly-attachable via pins/channels, detents/apertures or other equivalent means), designed to attach by way of virtually any snap-type connectors. In this way the present invention may be modularly constructed and de-constructed, as needed.

A cross bar (top horizontal support bar 150) may connect to the tops of the modular vertical frame posts 140 by way of the aforementioned corner units (lockable corner couplers 110), which may also lock into place with push-button locks or camming means. Removable bases may be included at the bottom of mobile patient lift systems 102 in preferred embodiments. Two slide attachments (stabilizer bar 410) may fit onto the bottom side bars, designed to sit across the end of bed 180 and provide stability if Tym-lyn Portable Lift 100 is being used to put patients into bed 180 at a side angle. Crank handle 210 may be used to manually hand-crank-manipulate the hanger portion (patient suspension bar 160) in relation to lifter 170, allowing it to lower/raise as desired. The handle can be raised to the top of the bar, where it may be attached by a hard mounted eye. The entire device can be approximately 74″ tall and 49″ wide, and may be adjusted as needed to suit user preferences.

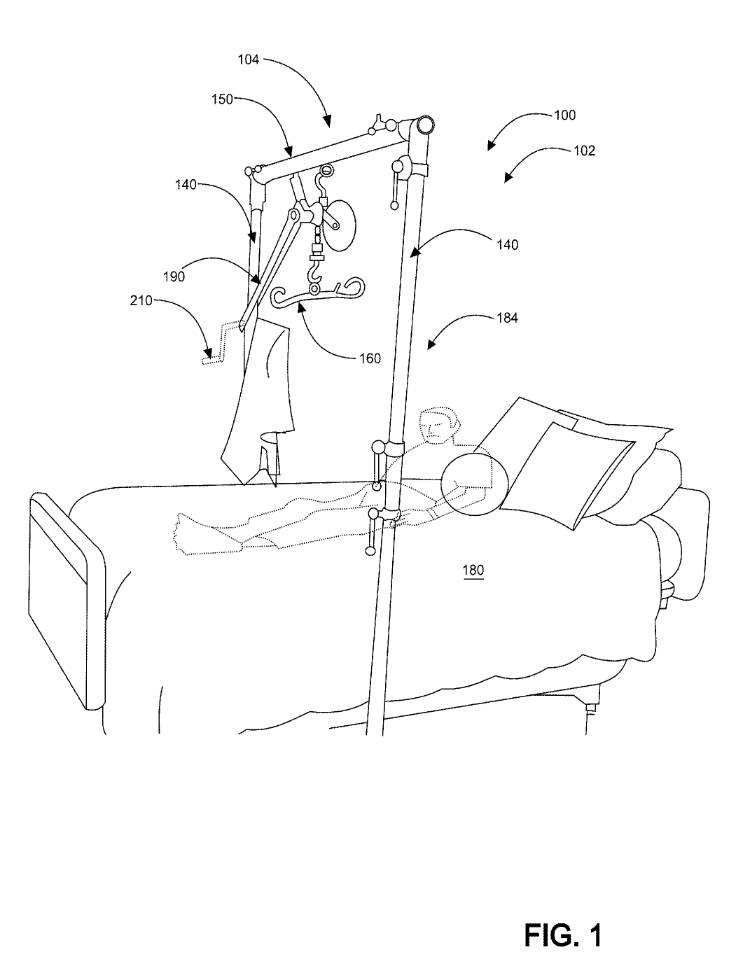

Now referring to the drawings more specifically by numerals of reference there is shown in FIG. 1, a perspective view illustrating Tym-lyn Portable Lift 100 in an in-use condition 184 according to an embodiment of the present invention.

Tym-lyn Portable Lift 100 (mobile patient lift system(s) 102) as disclosed herein preferably comprises a (modular) frame assembly 104 including a plurality of modular vertical frame posts 140, a plurality of variably lockable corner couplers 110, at least one top horizontal support bar 150 with a lifting eye 154; patient suspension bar 160; at least one lifter 170; a driver bar assembly 190; and at least two caster wheel assemblies 120. Upon reading this specification, it should be appreciated that, under appropriate circumstances, considering such issues as user preferences, design preference, structural requirements, marketing preferences, cost, available materials, technological advances, etc., other equivalent frames, lifters, with or without drive bar assembly arrangements such as, for example, block and tackle, come-alongs, hoists, etc., may be sufficient.

Frame assembly 104 as described previously preferably includes a plurality of modular vertical frame posts 140 coupled via a plurality of variably lockable corner couplers 110, and top horizontal support bar 150 with lifting eye 154, to form modular frame assembly 104 for mobile patient lift system 102. Frame assembly 104, as built is lightweight, durable, and easily maneuverable via a single caregiver in and around bed 180. Caster wheel assemblies 120 removably receive modular vertical frame posts 140 of frame assembly 104, thereby providing the desired mobility. Additionally, caster wheel assemblies 120 preferably include a plurality of swivelable wheels 122 to smoothly transport Tym-lyn Portable Lift 100 on a planar surface such as a hospital floor, a bedroom or other interior room. In this way Tym-lyn Portable Lift 100 (mobile patient lift systems 102) is able to lift and transport the patient between various locations in a variety of buildings/conditions.

Patient suspension bar 160 is removably connected to Tym-lyn Portable Lift 100 such that patient suspension bar 160 is able to be repeatably manipulated between up and down positions via driver bar assembly 190 to lift at least one patient, the patient removably attached to patient suspension bar 160. In this way the present invention is enabled for in-use condition 184.

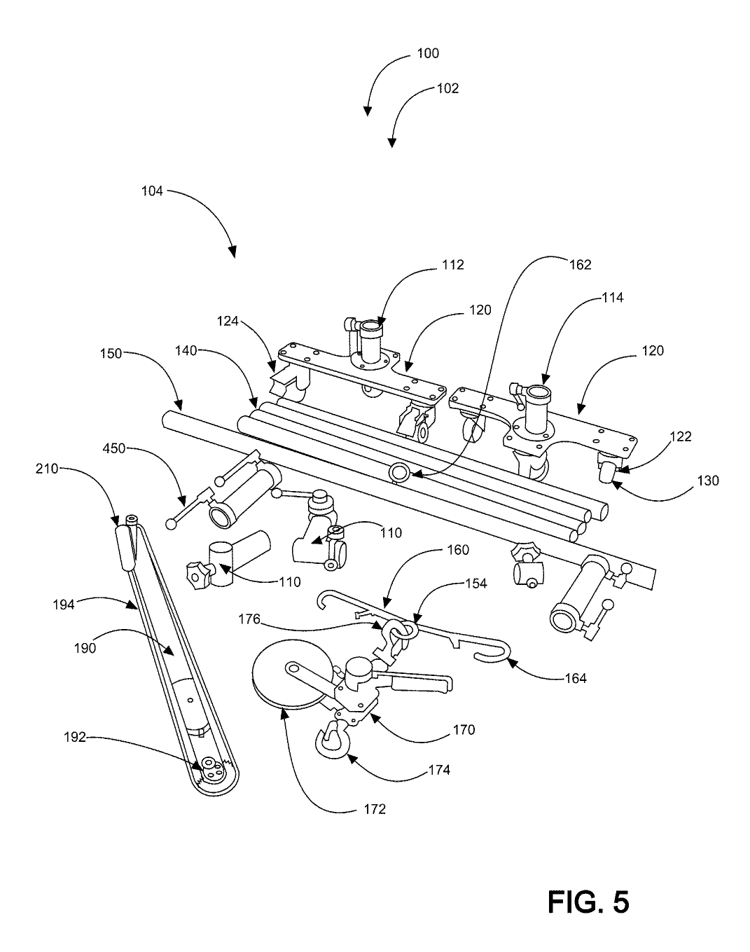

Variably lockable corner couplers 110 may comprise perpendicularly-oriented tube receivers 114 (for use in tubular constructions—round or square) such that top horizontal support bar 150 with lifting eye 154 is able to be removably coupled with modular vertical frame posts 140 at right angles to create an open plane wherein frame assembly 104 is able to circumvent bed 180. In this way the present invention is handy for use in lifting patients stably from out of bed 180, avoiding potentially tipping over and dropping the patient. Caster wheel assemblies 120 provide for ease of movement as well as lower the relative center of gravity (making it less top-heavy.) Variably lockable corner couplers 110 comprise biasing slits 112 wherein movement of biasing slits 112 is enabled by at least one rotatable lever, biasing slits 112 also shown in FIG. 5. Modular vertical frame posts 140 are received by lockable corner couplers 110 and/or vertical frame couplers 310 and/or caster wheel assemblies 120 wherein they may be locked for in-use condition 184 and unlocked for non-use condition 250.

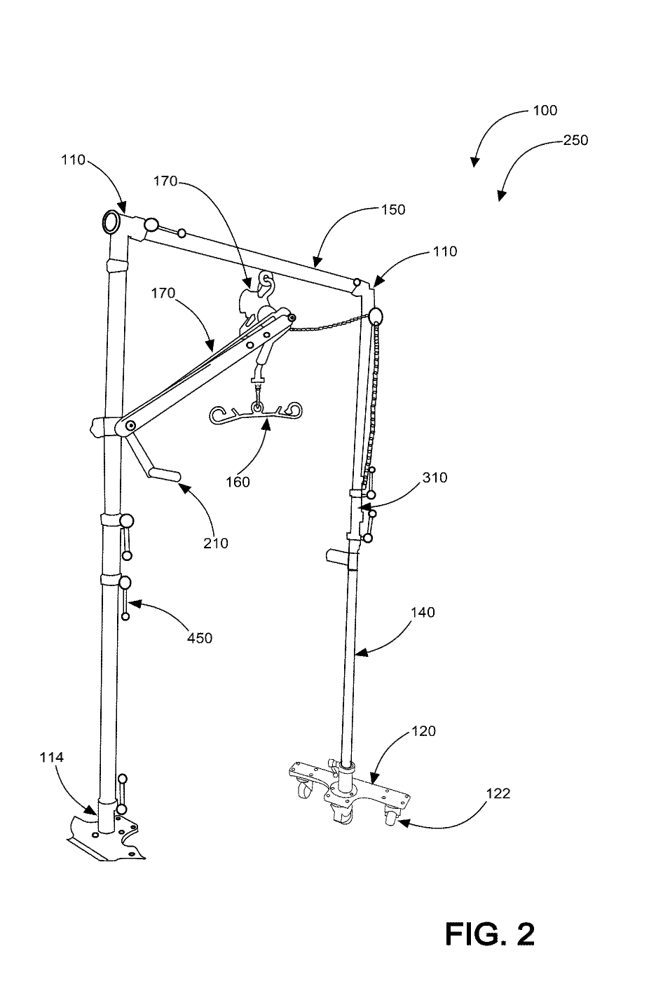

Referring now to FIG. 2, showing a perspective view illustrating Tym-lyn Portable Lift 100 in a non-use condition 250 according to an embodiment of the present invention of FIG. 1.

Non-use condition 250 may comprise (assembled or disassembled) storage conditions, instances of transporting between locations (such as from a hospital to home), movement to an out-of-the-way location or other. This is also facilitated via caster wheel assemblies 120. Wheel locks 124 may be used in these instances where it is desirable to keep mobile patient lift systems 102 in a assembled condition for ease of ready-use. Additionally, mobile patient lift systems 102 may be easily moved between various hospital rooms for example providing cost-effective use of the present invention. Further, the present FIG. 2 shows a good perspective view of driver bar assembly 190 further comprising crank handle 210 as used in certain embodiments (as shown) or an electric motor (not shown) in alternate embodiments.

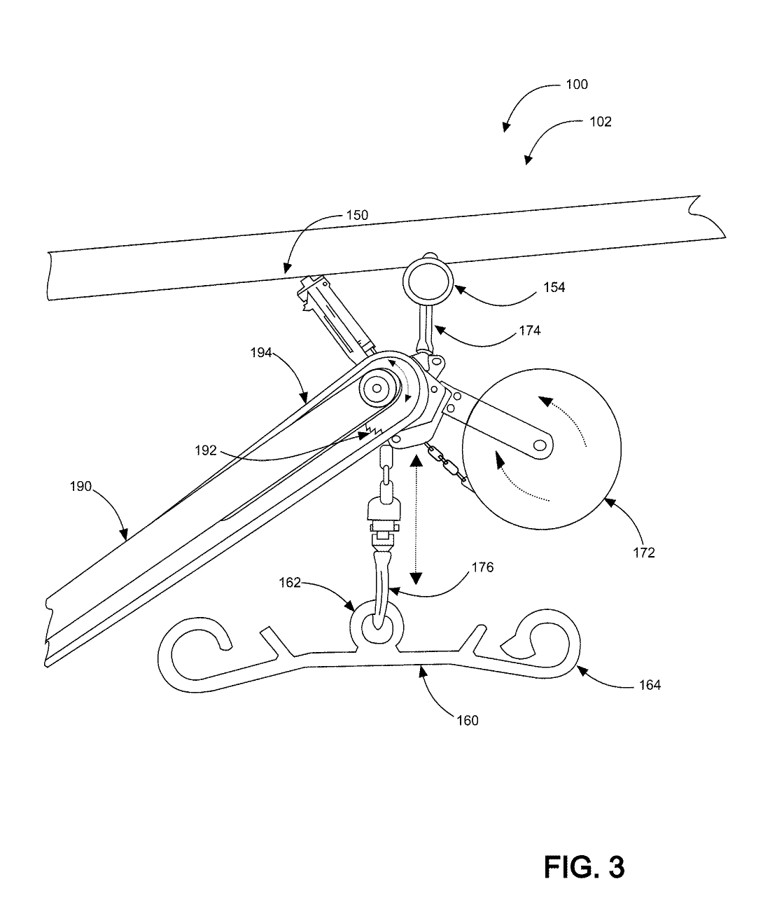

Referring now to FIG. 3, showing a perspective view illustrating lifter 170 as attached to top horizontal support bar 150 and to a modular vertical frame post 140 of frame assembly 104 of Tym-lyn Portable Lift 100 according to an embodiment of the present invention of FIG. 1.

Patient suspension bar 160, as shown, preferably comprises center-located lift-eyelet 162 and two opposing hooks 164. Lifter 170 may comprise spool 172; spool 172 provides chain-wrapping means (at least herein enabling chain-wrapper) to retain and dispense/intake a chain/cable/rope or the like. Lifter 170 preferably comprises a torque multiplier to provide a substantially easy lift for the caregiver. Lifter 170 comprises an upper hook 174 and a lower hook 176 in the embodiment shown however it should be appreciated that lifter 170 may be rigidly affixed if desired. In certain embodiments lifter 170 comprises a ratchet and pawl system to prevent undesirable movement in a direction opposing the desired direction of the user.

Driver bar assembly 190 may comprise at least two sprockets 192, and a (continuous) chain 194, as also detailed in FIG. 5. Driver bar 190 assembly may be removably-secured to lifter 170 such that when sprockets 192 move chain 194 on driver bar assembly 190 spool 172 on said lifter 170 is caused to move in accordance (wrapping or unwrapping.) In certain embodiments retraction means may be used.

For ease and efficiency of use driver bar assembly 190 is preferably angle-mounted between lifter 170 and one (side) of modular vertical frame posts 140; lifter 170 connected to top horizontal support bar 150 with lifting eye 154. Driver bar assembly 190 is angle-mounted between lifter 170 and one of modular vertical frame posts 140 such that crank handle 210 is able to be manipulated at a distance away (remote) from the patient so as not to create unnecessary obstacles and minimize chances of injury to the patient and/or caregiver.

Additionally, the present FIG. 3 shows modular vertical frame posts 140 as connectedly-coupled via vertical frame couplers 310 (acting in a similar capacity to lockable corner couplers 110—however different orientation and possibly different profile); however other clamping or connecting means may be used.

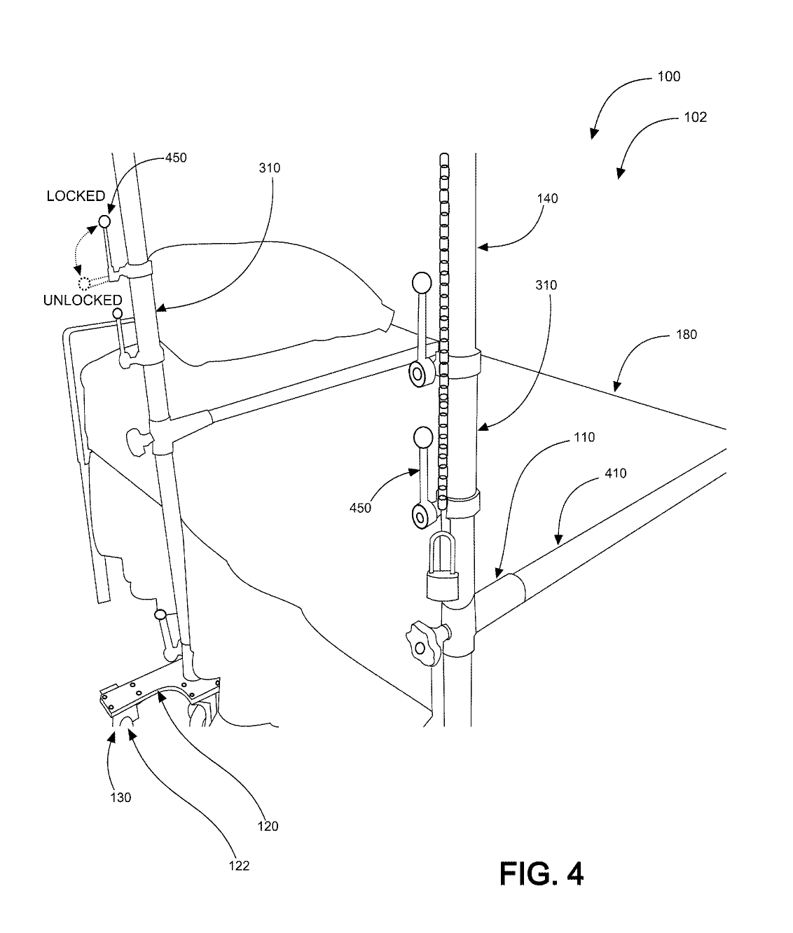

Referring now to FIG. 4, a perspective view illustrating two mobile patient lift systems 102 (Tym-lyn Portable Lift 100) in a stabilized condition circumventing a patient's bed (bed 180) according to an embodiment of the present invention of FIG. 1.

In the present figure mobile patient lift systems 102 is shown in another modular embodiment/configuration whereby a larger patient may be safely lifted, a patient may be lifted at an off-angle, a storage position is statically-retained or other possible scenario whereby stability is desirable as a feature. For these instances/circumstances at least one horizontal stabilizer bar 410 may be used as shown. Horizontal stabilizer bar 410 substantially prevents ‘diamonding of frame assembly 104. Caster wheel assemblies 120 comprise wheel locks 124 such that Tym-lyn Portable Lift 100 may be locked into a desired position relative to an object, here, shown as a bed 180.

Referring now to FIG. 5, showing a perspective view illustrating the various components of the Tym-lyn Portable Lift 100 according to an embodiment of the present invention of FIG. 1. In this figure mobile patient lift systems 102 is shown in a disassembled condition such as would be convenient for storage or shipping. Of notable mention is that rotatable lever 450 is conveniently illustrated to enable it as rotatable between locked and unlocked positions.

Tym-lyn Portable Lift 100 may be sold as a modular kit comprising the following parts: at least one frame assembly 104 (lockable corner couplers 110; modular vertical frame posts 140; top horizontal support bar 150); at least two caster wheel assemblies 120; at least one patient suspension bar 160; at least one lifter 170; at least one driver bar assembly 190; at least one crank handle 210; optionally vertical frame couplers 310 (with or without rotatable lever(s) 450); stabilizer bars 410; and at least one set of user instructions. Tym-lyn Portable Lift 100/mobile patient lift systems 102 may be manufactured and provided for sale in a wide variety of sizes and shapes for a wide assortment of room applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, parts may be sold separately, etc., may be sufficient.

A method for using a Tym-lyn Portable Lift 100 may comprise the steps of: orientating a patient on an object; manipulating Tym-lyn Portable Lift 100 over (around or other) an object (bed or chair or the like); coupling the patient (via sling or other) to Tym-lyn Portable Lift 100 to move the patient; and manipulating said Tym-lyn Portable Lift 100 from over said object. It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A mobile patient lift system comprising:
a frame assembly including,
a plurality of modular vertical frame posts,
a plurality of variably lockable corner couplers,
at least one top horizontal support bar with a lifting eye;
a patient suspension bar;
at least one lifter;
a driver bar assembly; and
at least two caster wheel assemblies;
wherein said frame assembly including said plurality of modular vertical frame posts coupled to said plurality of variably lockable corner couplers, and said top horizontal support bar with said lifting eye, form a modular said frame assembly for said mobile patient lift system;
wherein said patient suspension bar is removably connected to said lifter such that said patient suspension bar is able to be repeatably manipulated between up and down positions via said driver bar assembly to lift at least one patient, the patient removably attached to said patient suspension bar;
wherein said caster wheel assemblies removably receive said modular vertical frame posts of said frame assembly;
wherein said caster wheel assemblies include a plurality of swivelable wheels to smoothly transport said mobile patient lift system on a planar surface; and
wherein said mobile patient lift system is able to lift and transport the patient between various locations.

2. The mobile patient lift system of claim 1 wherein said variably lockable corner couplers comprise biasing slits wherein movement of said biasing slits is enabled by at least one rotatable lever.

3. The mobile patient lift system of claim 2 wherein said rotatable lever is rotatable between locked and unlocked positions.

4. The mobile patient lift system of claim 2 wherein said variably lockable corner couplers comprise perpendicularly-oriented tube receivers such that said top horizontal support bar with said lifting eye is able to be removably coupled with said modular vertical frame posts at right angles to create an open plane wherein said frame assembly is able to circumvent a bed.

5. The mobile patient lift system of claim 1 wherein said patient suspension bar comprises a center-located lift-eyelet and two opposing hooks.

6. The mobile patient lift system of claim 1 wherein said lifter comprises a spool.

7. The mobile patient lift system of claim 6 wherein said spool provides chain-wrapping means.

8. The mobile patient lift system of claim 6 wherein said lifter is a torque multiplier.

9. The mobile patient lift system of claim 6 wherein said lifter comprises an upper hook and a lower hook.

10. The mobile patient lift system of claim 6 wherein said lifter comprises a ratchet and pawl system.

11. The mobile patient lift system of claim 1 wherein said driver bar assembly comprises at least two sprockets, and a chain.

12. The mobile patient lift system of claim 11 wherein said driver bar assembly is removably-secured to said lifter such that when said sprockets move said chain on said driver bar assembly said spool on said lifter is caused to move rotationally in accordance.

13. The mobile patient lift system of claim 11 wherein said driver bar assembly further comprises a crank handle.

14. The mobile patient lift system of claim 11 wherein said driver bar assembly further comprises an electric motor.

15. The mobile patient lift system of claim 13 wherein said driver bar assembly is angle-mounted between said lifter and one of said modular vertical frame posts, said lifter connected to said top horizontal support bar with said lifting eye.

16. The mobile patient lift system of claim 15 wherein said driver bar assembly is angle-mounted between said lifter and one of said modular vertical frame posts such that said crank handle is able to be manipulated at a distance away from the patient.

17. The mobile patient lift system of claim 1 whereas said caster wheel assemblies comprise wheel locks.

18. The mobile patient lift system of claim 1 further comprising at least one horizontal stabilizer bar.

19. A mobile patient lift system comprising:
a frame assembly including,
a plurality of modular vertical frame posts,
a plurality of variably lockable corner couplers,
at least one top horizontal support bar with a lifting eye;
a patient suspension bar;
at least one lifter;
a driver bar assembly;
at least two caster wheel assemblies with wheel locks; and
at least one horizontal stabilizer bar connectable between said modular vertical frame posts via T-shaped couplers;
wherein said frame assembly including said plurality of modular vertical frame posts coupled to said plurality of variably lockable corner couplers, and said top horizontal support bar with said lifting eye, form a modular said frame assembly for said mobile patient lift system;
wherein said modular vertical frame posts, said top horizontal support bar with said lifting eye, and said horizontal stabilizer bar are telescopic;
wherein said variably lockable corner couplers comprise biasing slits wherein movement of said biasing slits is enabled by at least one rotatable lever;
wherein said rotatable lever(s) is rotatable between locked and unlocked positions;
wherein said variably lockable corner couplers comprise perpendicularly-oriented tube receivers such that said top horizontal support bar with said lifting eye is able to be removably coupled with said modular vertical frame posts at right angles to create an open plane wherein said frame assembly is able to circumvent a bed;
wherein said patient suspension bar comprises a center-located lift-eyelet and two opposing hooks;
wherein said lifter comprises a spool;
wherein said spool is a chain-wrapper;
wherein said lifter is a torque multiplier having an upper hook and a lower hook;
wherein said lifter comprises a ratchet and pawl system;
wherein said driver bar assembly comprises sprockets and a chain;
wherein said driver bar assembly is removably-secured to said lifter such that when said sprockets move said chain on said driver bar assembly said spool on said lifter is caused to move in rotational accordance;
wherein said driver bar assembly is angle-mounted between said lifter and one of said modular vertical frame posts, said lifter connected to said top horizontal support bar with said lifting eye;
wherein said driver bar assembly is angle-mounted between said lifter and one of said modular vertical frame posts such that said crank handle is able to be manipulated at a distance away from the patient;
wherein said driver bar assembly further comprises a crank handle or an electric motor;
wherein said patient suspension bar is removably connected to said lifter such that said patient suspension bar is able to be repeatably manipulated between up and down positions via said driver bar assembly to lift at least one said patient, the patient removably attached to said patient suspension bar;
wherein said caster wheel assemblies removably receive said modular vertical frame posts of said frame assembly;
wherein said caster wheel assemblies include a plurality of swivelable wheels to transport said mobile patient lift system on a planar surface; and
wherein said mobile patient lift system is able to lift and transport the patient between various locations.

20. A method for using a mobile patient lift system comprising the steps of:
orientating a patient on an object;
manipulating said mobile patient lift system over an object;
coupling the patient to said mobile patient lift system to move the patient; and
manipulating said mobile patient lift system from over said object.
